(19) United States
(12) Patent Application Publication
(10) Pub. No.: US 2008/0079867 A1
(43) Pub. Date: Apr. 3, 2008

(54) DISPLAY APPARATUS

(75) Inventor: Yeon-Sik HAM, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/862,822

(22) Filed: Sep. 27, 2007

(30) Foreign Application Priority Data
Sep. 27, 2006 (KR) 10-2006-0094334

(51) Int. Cl. G02F 1/1335

(52) U.S. Cl. 349/62

(57) ABSTRACT

A display apparatus includes a display panel on which pixel areas are defined, and each pixel area includes a light transmission area and a light blocking area. Color filters are arranged in the light transmission area, and a black matrix is arranged in the light blocking area. At least one pixel area has a pixel aperture ratio that satisfies a modulation value of the display panel less than 0.01. The modulation value is influenced by the pixel aperture ratio, an interval between the peaks of adjacent prisms on a prism sheet, the width of the inclined surface of a prism on the prism sheet, and the ratio of the width of the pixel area to the prism peak interval.

### CROSS-REFERENCE TO RELATED APPLICATION

This application claims priority from and the benefit of Korean Patent Application No. 10-2006-0094334, filed on Sep. 27, 2006, which is hereby incorporated by reference for all purposes as if fully set forth herein.

### BACKGROUND OF THE INVENTION

1. Field of the Invention

The present invention relates to a display apparatus, and more particularly, to a display apparatus capable of improving an image quality.

2. Discussion of the Background

A Liquid Crystal Display (LCD) includes an LCD panel for displaying an image and a backlight assembly for providing light to the LCD panel.

The LCD panel includes an array substrate, a color filter substrate facing the array substrate, and a liquid crystal layer interposed between the array substrate and the color filter substrate. The color filter substrate includes pixels, which are basic elements used to display an image. Each pixel includes a thin film transistor connected to a pixel electrode. The thin film transistor switches a pixel voltage provided to the liquid crystal layer. The pixel electrode is connected to a drain electrode of the thin film transistor, and is opposed to a common electrode arranged on the color filter substrate. The liquid crystal layer is interposed between the pixel electrode and the common electrode, and includes liquid crystal molecules that change alignment in response to a potential difference between the pixel electrode and the common electrode.

The LCD is thin compared with a Cathode Ray Tube (CRT) display apparatus, but the LCD may have a narrower viewing angle.

In order to improve the viewing angle of the LCD, a Patterned Vertical Alignment (PVA) LCD panel and a Super-Patterned Vertical Alignment (S-PVA) LCD panel having wider viewing angles have been developed. In PVA LCD and S-PVA LCD panels, a pixel electrode and a common electrode are patterned to define more than one domain per pixel, and liquid crystal molecules of the liquid crystal layer are aligned in different directions in different domains.

As described above, in the PVA LCD panel and the S-PVA LCD panel, since a pixel electrode and a common electrode are patterned, optical interference may occur between the LCD panel and a prism sheet of the backlight assembly. Therefore, a moiré phenomenon may occur, and another defect may occur where certain pixels in the LCD panel appear as white dots to an observer.

### SUMMARY OF THE INVENTION

This invention provides a display apparatus capable of improving display characteristics and a product yield thereof.

Additional features of the invention will be set forth in the description which follows, and in part will be apparent from the description, or may be learned by practice of the invention.

The present invention discloses a display apparatus includes a light source unit to generate light, a display panel and an optical member interposed between the light source unit and the display panel to collect light from the light source unit and to provide the display panel with the collected light. The display panel includes a base substrate including a plurality of pixel areas, each pixel area including a light transmission area and a light blocking area surrounding the light transmission area, color filters arranged in the pixel areas, and a black matrix arranged in the light blocking area of the pixel areas. A pixel aperture ratio is a ratio of the light transmission area to a corresponding pixel area, and a first pixel area has a first pixel aperture ratio and a modulation value less than 0.01. The modulation value equals a difference between a maximum luminance and a minimum luminance of the display panel in a first gray scale divided by a sum of the maximum luminance and the minimum luminance.

The present invention also discloses a display apparatus includes a light source unit to generate light, a display panel and an optical member interposed between the light source unit and the display panel to collect light from the light source unit and to provide the display panel with the collected light. The display panel includes a base substrate including a plurality of pixel areas, each pixel area including a light transmission area and a light blocking area surrounding the light transmission area, color filters arranged in the pixel areas, and a black matrix arranged in the light blocking area. A pixel aperture ratio is a ratio of the light transmission area to a corresponding pixel area, and at least one pixel area has a pixel aperture ratio of 0.90 to 0.99 and a modulation value less than 0.01. The modulation value equals a difference between maximum luminance and minimum luminance of the display panel in a gray scale higher than highlights divided by a sum of the maximum luminance and the minimum luminance.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a section view illustrating an LCD according to an exemplary embodiment of the present invention.

FIG. 2 is a section view illustrating a prism sheet shown in FIG. 1.

FIG. 3 is a plan view illustrating an LCD panel shown in FIG. 1.

FIG. 4 is a plan view illustrating a color filter substrate shown in FIG. 3.

FIG. 5 is a section view taken along line I-I′ shown in FIG. 4.

FIG. 6 is an enlarged section view of region ‘A’ shown in FIG. 5.

FIG. 7 is a graph illustrating the relationship of modulation value to ratio of pixel area width to prism peak interval according to a pixel aperture ratio.

FIG. 8 is a plan view illustrating a color filter substrate according to another exemplary embodiment of the present invention.

FIG. 9 is a section view taken along line II-II′ shown in FIG. 8.

FIG. 10 is an enlarged section view of region ‘B’ shown in FIG. 9.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. It will be understood that when an element such as a layer, film, region, or substrate is referred to as being “on” another element, it can be directly on the other element or intervening elements may also be present.

Hereinafter, exemplary embodiments of the present invention will be explained in detail with reference to the accompanying drawings.

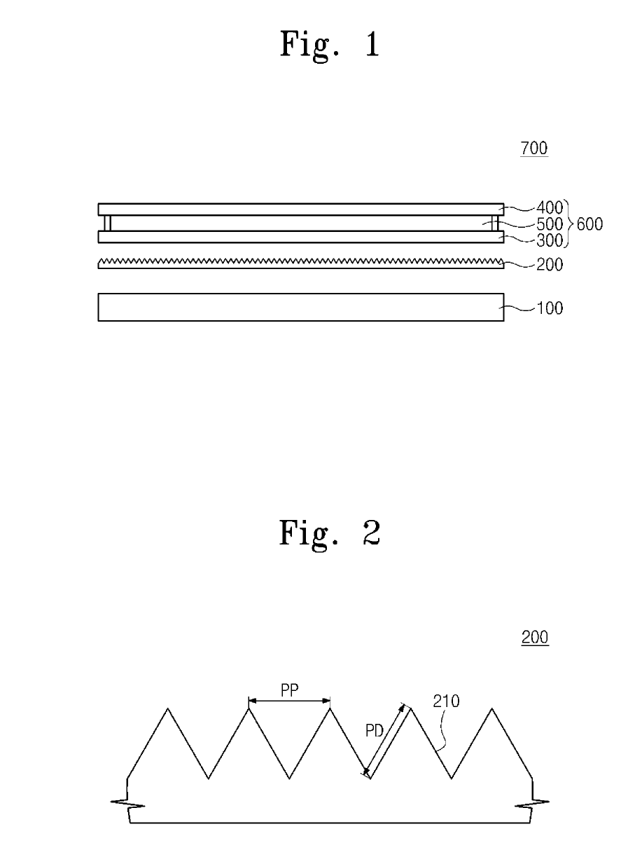

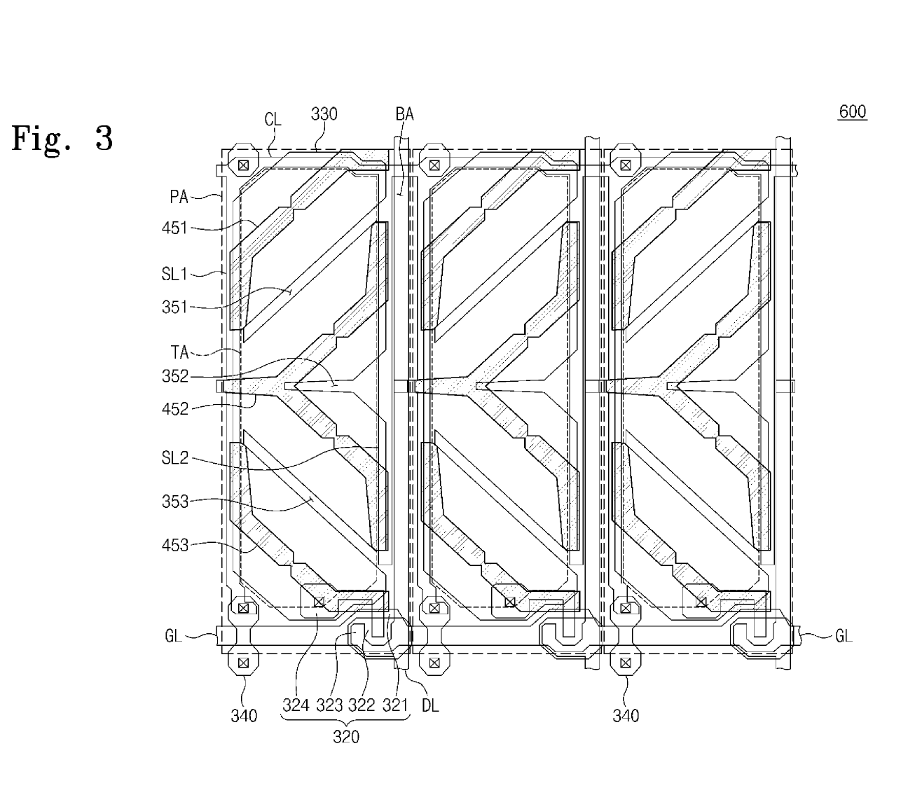

FIG. 1 is a section view illustrating an LCD according to an exemplary embodiment of the present invention, FIG. 2 is a section view illustrating a prism sheet shown in FIG. 1, and FIG. 3 is a plan view illustrating an LCD panel shown in FIG. 1.

Referring to FIG. 1 and FIG. 2, an LCD 700 includes a light source unit 100 for generating light, a prism sheet 200 for collecting the light, and an LCD panel 600 for displaying an image using the light. The LCD panel 600 includes an array substrate 300, a color filter substrate 400, and a liquid crystal layer 500 arranged between the array substrate 300 and the color filter substrate 400.

The light source unit 100 generates light, and the prism sheet 200 collects the light from the light source unit 100 and provides the light to the LCD panel 600. In the present exemplary embodiment, the LCD 700 includes a prism sheet 200 as an optical sheet. However, the LCD 700 may include one or more additional optical sheets.

The prism sheet 200 includes prisms 210 arranged on an upper surface thereof to collect the light from the light source unit 100. The prisms 210 may have triangular cross-sections and may be arranged adjacent to each other. Each prism includes two inclined surfaces, and the distances PP between peaks of adjacent prisms 210 may be identical across the prism sheet 200. The distance PP will be referred to as a prism peak interval PP. PD denotes the width PD of an inclined surface of a prism 210 on the prism sheet 200.

Referring to FIG. 1 and FIG. 3, the LCD panel 600 is disposed on the prism sheet 200. Pixel areas PA in which an image is displayed are defined on the LCD panel 600, and each pixel area PA may include a light transmission area TA and a light blocking area BA.

The array substrate 300 of the LCD panel 600 includes gate lines GL for transmitting gate signals, data lines DL for transmitting data signals, thin film transistors 320 for switching a pixel voltage, and pixel electrodes 330 for receiving the pixel voltage.

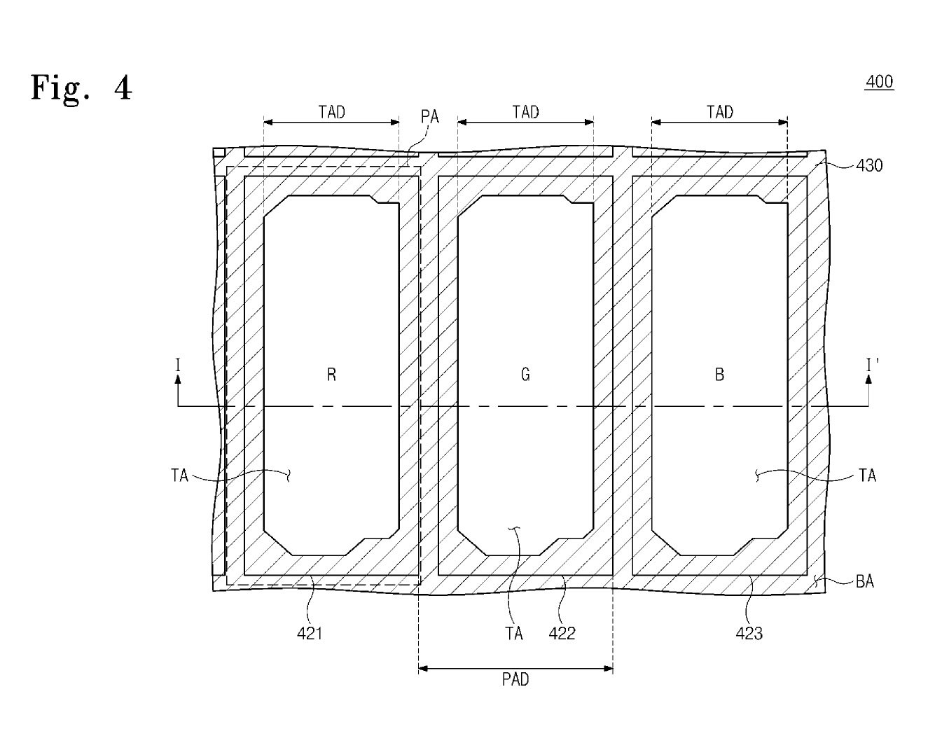

The gate lines GL are insulated from the data lines DL while crossing with the data lines DL, and define the pixel areas PA in combination with the data lines DL. The thin film transistor 320 and the pixel electrode 330 are arranged in the pixel area PA, and the thin film transistor 320 is arranged in a light blocking area BA shown in FIG. 3 and FIG. 4. The thin film transistor 320 includes a gate electrode 321 extending from a corresponding gate line GL, a semiconductor layer 322 arranged corresponding to and insulated from the gate electrode 321, a source electrode 323 arranged on the semiconductor layer 322 while extending from a corresponding data line DL, and a drain electrode 324 arranged on the same layer with the source electrode 323 and connected to the pixel electrode 330.

The pixel electrode 330 may be formed of a transparent conductive material, such as Indium Zinc Oxide (IZO) or Indium Tin Oxide (ITO), and receives the pixel voltage. The pixel electrode 330 is patterned such that the pixel area PA is divided into domains in which the liquid crystal molecules of the liquid crystal layer 500 are aligned in different directions. That is, the pixel electrode 330 may be arranged substantially parallel to the gate lines GL, and may include a central opening 352 along a virtual line crossing the central portion of the pixel area PA. The pixel electrode 330 may include additional openings 351 and 353 inclined at a predetermined angle with respect to the virtual line. The pixel electrode 330 may be symmetrical about the virtual line.

The array substrate 300 further includes a common voltage line CL for transmitting a common voltage, a first storage line SL1, and a second storage line SL2. The common voltage line CL extends substantially parallel with the gate line GL, and the first storage line SL1 and the second storage line SL2 extend from the common voltage line CL. The first storage line SL1 and the second storage line SL2 are arranged in the pixel area PA, and extend substantially parallel with the data line DL to oppose each other about the pixel area PA. When viewed in a plan view, the first storage line SL1 and the second storage line SL2 partially overlap with the pixel electrode 330 so that a storage capacitor is formed therebetween.

The array substrate 300 further includes a connection electrode 340 that connects adjacent common voltage lines CL to each other. The connection electrode 340 may be formed of a same material as the pixel electrode 330. The connection electrode 340 is connected to the first storage line SL1 and the common voltage line CL arranged in an adjacent pixel area, and the connection electrode 340 extends in a longitudinal direction substantially parallel with the data line DL.

The color filter substrate 400 is disposed opposite to the array substrate 300 with the liquid crystal layer 500 arranged therebetween.

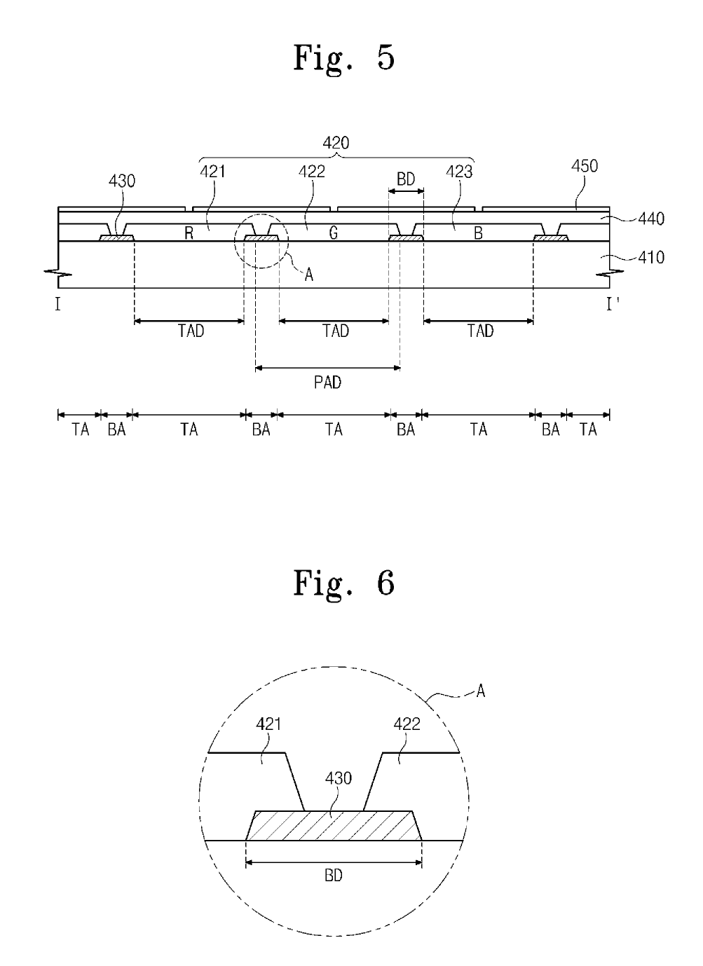

FIG. 4 is a plan view illustrating the color filter substrate shown in FIG. 3, FIG. 5 is a section view taken along line I-I′ shown in FIG. 4, and FIG. 6 is an enlarged section view of region ‘A’ shown in FIG. 4.

Referring to FIG. 4, FIG. 5, and FIG. 6, the color filter substrate 400 includes a base substrate 410, color filters 420, a black matrix 430, an overcoat layer 440, and a common electrode 450.

The color filters 420 and the black matrix 430 are arranged on the base substrate 410. The color filters 420 may include a red color filter 421, a green color filter 422, and a blue color filter 423 that respectively produce red, green, and blue light from the light generated by the light source unit 100, and the red color filter 421, the green color filter 422, and the blue color filter 423 may be arranged in the pixel areas PA of three adjacent pixels. The black matrix 430 is arranged in the light blocking area BA to block the light, and surrounds the color filters 420. The red color filter 421, the green color filter 422, and the blue color filter 423 are arranged in the light transmission area TA and the light blocking area BA, and partially overlap with the black matrix 430 in the light blocking area BA.

The overcoat layer 440 and the common electrode 450 are sequentially arranged on the color filters 420 and the black matrix 430. The overcoat layer 440 planarizes the color filter substrate 400, and the common electrode 450 faces the pixel electrode 330 with the liquid crystal layer 500 interposed therebetween. The common electrode 450 may be formed of a transparent conductive material, such as IZO or ITO, and include openings 451, 452 and 453 in the pixel area PA to form the domains as shown in FIG. 3.

As described above, since the pixel area PA is divided into domains in the LCD panel 600, viewing angle may be improved. However, certain pixels may be observed as white dots due to optical interference with the prism sheet 200.

Referring to FIG. 2, FIG. 4, FIG. 5, and FIG. 6, a defect may be caused by a relation between the width PAD of the pixel area PA and the prism peak interval PP of the prism sheet 200. The width PAD and the prism peak interval PP influence the luminance of the LCD panel 600, which may be calculated by Equation 1 below.

$$I = \{ PR \times ( 1 + {\sum }_{N = 1}^{∞} 2 \frac{sin ( N \times K 1 \times \frac{TAD}{2} )}{( N \times K 1 \times \frac{TAD}{2} )} \times cos ( N \times K 1 \times x ) ) \} \times \{ \frac{PD}{PP} \times ( 1 + {\sum }_{M = 1}^{∞} 2 \frac{sin ( M \times K 2 \times \frac{PD}{2} )}{( M \times K 2 \times \frac{PD}{2} )} \times cos ( M \times K 2 \times x ) ) \} \qquad Equation 1$$

In Equation 1, I denotes the luminance of the LCD panel 600, PR denotes a pixel aperture ratio, N denotes the value obtained by dividing the width PAD of the pixel area PA by the prism peak interval PP, K1 denotes the frequency of the LCD panel 600, K2 denotes the frequency of the prism sheet 200, TAD denotes the width TAD of the light transmission area TA, PD denotes the width PD of the inclined surface of a prism 210 on the prism sheet 200, M denotes the value obtained by dividing the prism peak interval PP by the prism width PD, x denotes x-axis coordinate of point which recognized moiré in the LCD panel 600, and PP denotes the prism peak interval PP. The pixel aperture ratio PR denotes a ratio of the light transmission area TA to the pixel area PA, and equals a ratio of the width TAD of the light transmission area TA to the width PAD of the pixel area PA. The width PAD of the pixel area PA equals the sum of a width of a color filter 420 arranged on a corresponding pixel area PA and the distance between adjacent color filters 420.

Referring to Equation 1, the luminance I of the LCD panel 600 is influenced by the pixel aperture ratio PR, the prism peak interval PP, and the width PD of the inclined surface of a prism 210 on the prism sheet 200.

Equation 1 can be expressed as the following Equation 2 by using frequency components of the LCD panel 600 and the prism sheet 200.

$$I = \frac{TAD}{PAD} \times \frac{PD}{PP} \times \{ 1 + 2 \times \frac{sin ( N \times K 1 \times \frac{TAD}{2} )}{( N \times K 1 \times \frac{TAD}{2} )} \times \frac{sin ( M \times K 2 \times \frac{PD}{2} )}{( M \times K 2 \times \frac{PD}{2} )} \times cos ( ( ( N \times K 1 ) - ( M \times K 2 ) ) \times x ) \} \qquad Equation 2$$

In Equation 2, N and M denote fractions satisfying predetermined conditions including: (N×K1)−(M×K2)<<K1 and (N×K1)−(M×K2)<<K2. The occurrence period of the defect and the modulation value representing whether the defect has occurred can be calculated by Equation 3 and Equation 4 below.

$$\begin{matrix}occurrence period = \frac{2 π}{( N \times K 1 ) - ( M \times K 2 )} = \frac{1}{\frac{N}{PAD} - \frac{M}{PP}} & Equation 3 \\ modulation value = \frac{L 1 - L 2}{L 1 + L 2} = \vert \frac{4}{π} \times \frac{sin ( N \times K 1 \times \frac{TAD}{2} )}{( N \times K 1 \times \frac{TAD}{2} )} \times \frac{sin ( N \times K 2 \times \frac{PD}{2} )}{( N \times K 2 \times \frac{PD}{2} )} \vert & Equation 4\end{matrix}$$

In Equation 4, L1 denotes the maximum luminance value of the LCD panel 600 in a gray scale in which the defect can be recognized, and L2 denotes the minimum luminance value of the LCD panel 600 in a gray scale in which the defect can be recognized.

Referring to Equation 3 and Equation 4, the modulation value is obtained by dividing the difference between the maximum luminance value L1 and the minimum luminance value L2 of the LCD panel 600 in the gray scale in which the defect can be recognized, which shall be referred to as the gray scale higher than highlight and equal to or less than shadow, by the sum of the maximum luminance value L1 and the minimum luminance value L2. The defect cannot be recognized substantially in the highlight. As described above, since the modulation value is determined by the luminance of the LCD panel 600, the degree of visibility for the defect is also determined by the luminance of the LCD panel 600.

The luminance of the LCD panel 600 is influenced by the pixel aperture ratio PR, the prism peak interval PP, and the width PD of the inclined surface of a prism 210 on the prism sheet 200 as expressed by Equation 1 and Equation 2. Accordingly, the modulation value is also influenced by the width PAD of the pixel area PA, the prism peak interval PP, and the width PD of the inclined surface of a prism 210 on the prism sheet 200. Equation 4 can be expressed as Equation 5 on the assumption that the frequency of the LCD panel 600 is approximately equal to the frequency of the prism sheet 200.

$$modulation value = \vert \frac{4}{π} \times \frac{sin ( π \times N \times PR )}{( π \times N \times PR )} \times \frac{sin ( π \times PR \times PPR )}{( π \times PR \times PPR )} \vert \\ PPR = \frac{PP \div PD}{PR} \qquad Equation 5$$

In Equation 5, PR denotes the pixel aperture ratio, and PPR denotes the ratio of the pixel aperture ratio PR to the curvature ratio of the prism sheet 200.

Referring to Equation 5, the ratio PPR of the pixel aperture ratio PR to the curvature ratio of the prism sheet 200 is obtained by dividing a ratio of the prism peak interval PP to the width PD of the inclined surface of a prism 210 on the prism sheet 200 by the pixel aperture ratio PR. The modulation value is influenced by the pixel aperture ratio PR, and the ratio PPR of the pixel aperture ratio to the curvature ratio of the prism sheet 200.

As described above, the modulation value is influenced by the pixel aperture ratio PR, the prism peak interval PP, the width PD of the inclined surface of a prism 210 on the prism sheet 200, and the ratio of the width PAD of the pixel area PA to the prism peak interval PP.

When the modulation value is less than 0.01, the LCD 700 may reduce the defect in which certain pixels are recognized as white dots. To this end, the LCD panel 600 may have a pixel aperture ratio PR where the modulation value is less than 0.01. That is, when the modulation value is less than 0.01, the optical interference between the LCD panel 600 and the prism sheet 200 is reduced, so that the defect may be reduced. Specifically, the LCD panel 600 may have a pixel aperture ratio PR that satisfies the modulation value greater than about 0.000001 and less than about 0.008.

As expressed by Equation 1, Equation 2, Equation 3, Equation 4, and Equation 5, the modulation value is influenced by the pixel aperture ratio PR, the prism peak interval PP, and the width PD of the inclined surface of a prism 210 on the prism sheet 200. Accordingly, the pixel aperture ratio PR is adjusted based on the prism peak interval PP and the width PD of the inclined surface of a prism 210 on the prism sheet 200 so that the modulation value is less than 0.01.

In the present exemplary embodiment, when the prism peak interval PP is identical to the width PD of the inclined surface of a prism 210 on the prism sheet 200, and the width PAD of the pixel area PA is about one to nine times greater than the prism peak interval PP, the pixel aperture ratio PR that satisfies the modulation value less than 0.01 may be about 0.90 to 0.99. Since the pixel aperture ratio PR denotes the ratio of the width TAD of the light transmission area TA to the width PAD of the pixel area PA, the pixel aperture ratio PR is influenced by the width TAD of the light transmission area TA.

When the prism peak interval PP and the width PD of the inclined surface of a prism 210 on the prism sheet 200 each have a value of about 50 μm, and the width PAD of the pixel area PA has a value of about 90 μm, the pixel aperture ratio PR that satisfies the modulation value less than 0.01 has a value of about 0.92. In the present exemplary embodiment, when the pixel area PA has a width PAD of about 90 μm, the light transmission area TA has a width TAD of about 83.2 μm, and the black matrix 810 has a width BD of approximately 6.8 μm, such that the pixel aperture ratio has a value of about 0.92. Thus, in relation to the pixel area PA, the width TAD of the light transmission area TA is increased and the width BD of the black matrix 430 is decreased as compared to the related art.

In an exemplary embodiment, all pixel areas PA of the LCD panel 600 may have the same width, and all light transmission areas TA also may have the same width TAD. Accordingly, all pixel areas PA of the LCD panel 600 may have the same pixel aperture ratio PR.

As described above, the pixel aperture ratio PR of the LCD panel 600 may be adjusted by adjusting the width TAD of the light transmission area TA so the modulation value of the LCD panel 600 is less than 0.01. In this way, the optical interference between the LCD panel 600 and the prism sheet 200 may be reduced, and the moiré phenomenon and the defect may also be reduced. As a result, the display characteristic and the product yield of the LCD panel 600 may be improved.

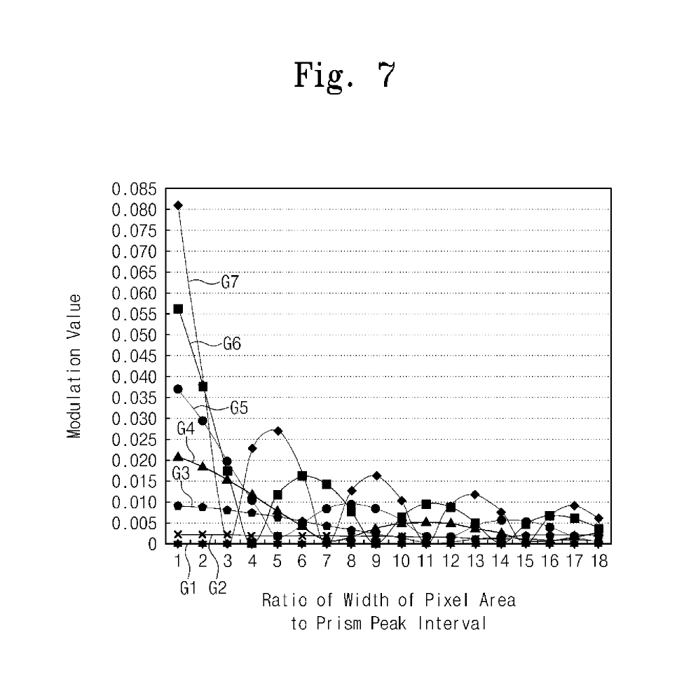

FIG. 7 is a graph illustrating the relationship of modulation value to ratio of pixel area width to prism peak interval according to a pixel aperture ratio.

Referring to FIG. 5, FIG. 6, and FIG. 7, first to seventh graphs G1 to G7 represent the variation in the modulation value with respect to pixel aperture ratio PR when the prism peak interval PP is identical to the width PD of the inclined surface of a prism 210 on a prism sheet 200.

Referring to FIG. 7, the values of the pixel aperture ratio PR in the first to seventh graphs G1 to G7 are as follows:

| Graph | Pixel Aperture Ratio PR |
|---|---|
| G1 | 1.0 |
| G2 | 0.96 |
| G3 | 0.92 |
| G4 | 0.88 |
| G5 | 0.84 |
| G6 | 0.80 |
| G7 | 0.75 |

As shown in FIG. 7, the modulation value is less than 0.01 in the first graph G1, the second graph G2, and the third graph G3, in which the pixel aperture ratio PR has a value greater than about 0.90. However, the modulation value is greater than 0.01 in the fourth graph G4, the fifth graph G5, the sixth graph G6, and the seventh graph G7, in which the pixel aperture ratio PR has a value less than about 0.90. Thus, when the pixel aperture ratio PR has a value greater than about 0.90, the defect may be reduced since the modulation value is less than 0.01.

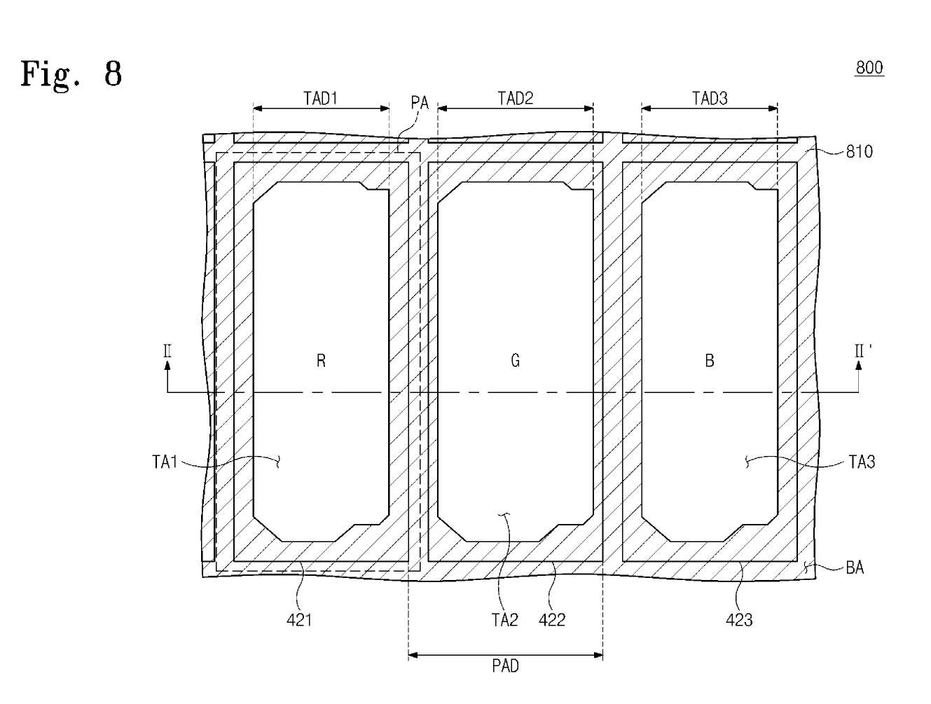

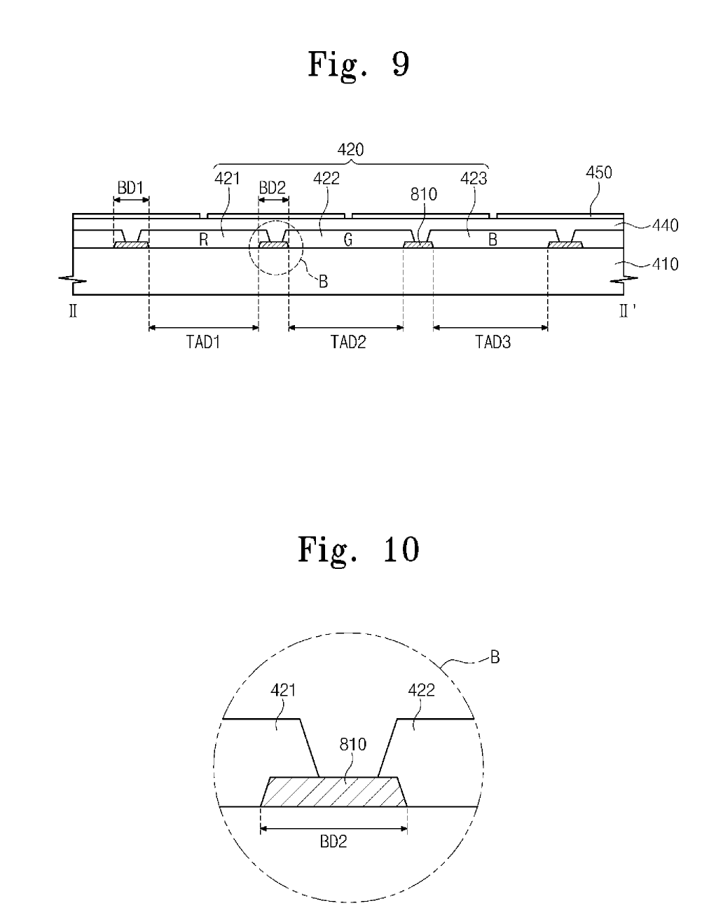

FIG. 8 is a plan view illustrating a color filter substrate according to another exemplary embodiment of the present invention, FIG. 9 is a section view taken along line II-II′ shown in FIG. 8, and FIG. 10 is an enlarged section view of region ‘B’ shown in FIG. 9.

Referring to FIG. 2, FIG. 8, FIG. 9, and FIG. 10, the color filter substrate 800 has substantially similar construction as that of the color filter substrate 400 shown in FIG. 3, FIG. 4, FIG. 5, and FIG. 6, except for the black matrix 810. In the following description of the color filter substrate 800, the same reference numerals will be assigned to the elements substantially identical to those of the color filter substrate 400 shown in FIG. 3, FIG. 4, FIG. 5, and FIG. 6, and detailed description thereof will be omitted.

The color filter substrate 800 includes a base substrate 410, color filters 420, a black matrix 810, an overcoat layer 440, and a common electrode 450. Pixel areas PA representing an image are defined on the base substrate 410, and each pixel area PA includes light transmission areas TA1, TA2 and TA3 and a light blocking area BA surrounding the light transmission areas TA1, TA2 and TA3.

The color filters 420 include a red color filter 421, a green color filter 422, and a blue color filter 423 arranged on the pixel areas PA. The black matrix 810 surrounds the color filters 420, and is arranged in the light blocking area BA to block the light.

Unlike as shown in FIG. 4, the light transmission areas TA1, TA2 and TA3 shown in FIG. 8 have different widths depending on color filters 420 arranged in corresponding pixel areas PA. In the present exemplary embodiment shown in FIG. 8, the light transmission area TA2 including the green color filter 422 is wider than the light transmission areas TA1 and TA3, in which the other color filters are arranged. This is because the green color filter 422 may have a luminance higher than that of the red color filter 421 and the blue color filter 423. Accordingly, the light transmission area TA2 including the green color filter 422 may be wider.

In detail, the pixel area including the green color filter 422 has a pixel aperture ratio PR that satisfies the modulation value less than 0.005 such that the optical interference between the LCD panel 600 and the prism sheet 200 is minimized. For convenience of description, the light transmission area TA1 in which the red color filter 421 is arranged will be referred to as the first light transmission area TA1, the light transmission area TA2 in which the green color filter 422 is arranged will be referred to as the second light transmission area TA2, and the light transmission area TA3 in which the blue color filter 423 is arranged will be referred to as the third light transmission area TA3.

In the present exemplary embodiment, when the prism peak interval PP is identical to the width PD of the inclined surface of a prism 210 on the prism sheet 200, and the width PAD of the pixel area PA is about one to nine times greater than the prism peak interval PP, the pixel aperture ratio PR of the pixel area including the green color filter 422 has a value of about 0.90 to about 0.99.

When the prism peak interval PP and the width PD of the inclined surface of a prism 210 on the prism sheet 200 each have a value of about 50 μm, and the width PAD of the pixel area PA has a value of about 90 μm, the pixel aperture ratio PR that satisfies the modulation value less than 0.01 has a value of about 0.92. When the pixel area PA has a width PAD of about 90 μm, the second light transmission area TA2 has a width TAD2 of about 83.2 μm such that the pixel aperture ratio of the pixel area PA including the green color filter 422 has a value of about 0.92. Accordingly, in relation to the pixel area PA including the green color filter 422, the width TAD2 of the second light transmission area TA2 is increased and the width BD2 of the black matrix 810 is decreased.

That is, the width TAD2 of the second light transmission area TA2 is wider than the width TAD1 of the first light transmission area TA1 and the width TAD3 of the third light transmission area TA3. Thus, the width BD2 of the black matrix 810 located between the first light transmission area TA1 and the second light transmission area TA2 is narrower than the width BD1 of the black matrix 810 located between the first light transmission area TA1 and a third light transmission area TA3 of an adjacent pixel area PA. The width of the black matrix 810 located between the second light transmission area TA2 and the third light transmission area TA3 may be substantially similar to the width BD2 of the black matrix 810 located between the first light transmission area TA1 and the second light transmission area TA2.

In this way, the pixel area PA including the green color pixel 422 has the pixel aperture ratio PR that satisfies the modulation value less than 0.01. Consequently, the optical interference between the LCD panel 600 and the prism sheet 200 may be reduced, and the moiré phenomenon and the defect may also be reduced. As a result, the display characteristic and the product yield of the LCD panel 600 may be improved.

According to the LCD panel, the width of the black matrix is decreased, and the pixel aperture ratio PR is increased. Accordingly, the LCD panel has the modulation value less than 0.01, so that the optical interference with the prism sheet may be reduced and the moiré phenomenon and the defect may also be reduced, resulting in the improvement of the display characteristics and the product yield.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a light source unit to generate light;
a display panel comprising a base substrate including a plurality of pixel areas, each pixel area including a light transmission area and a light blocking area surrounding the light transmission area, color filters arranged in the pixel areas, and a black matrix arranged in the light blocking area of the pixel areas; and
an optical member interposed between the light source unit and the display panel to collect light from the light source unit and to provide the display panel with the collected light,
wherein a pixel aperture ratio is a ratio of the light transmission area to a corresponding pixel area, and a first pixel area has a first pixel aperture ratio and a modulation value less than 0.01, and
wherein the modulation value equals a difference between a maximum luminance and a minimum luminance of the display panel in a first gray scale divided by a sum of the maximum luminance and the minimum luminance, and the first gray scale is higher than highlights.

2. The display apparatus of claim 1, wherein the optical member comprises a plurality of prisms, the prisms each having a triangular cross-section being arranged adjacent to each other to collect the light from the light source unit, and
wherein peaks of adjacent prisms are spaced apart from each other at a first distance.

3. The display apparatus of claim 2, wherein the modulation value is determined by a ratio of a width of the first pixel area to the first distance and the first pixel aperture ratio, the width of the first pixel area equals a sum of a distance between two adjacent color filters and a width of a color filter arranged in the first pixel area, and the first pixel aperture ratio equals a width of the light transmission area divided by the width of the first pixel area.

4. The display apparatus of claim 3, wherein the width of the first pixel area is one to nine times greater than the first distance.

5. The display apparatus of claim 4, wherein the first pixel aperture ratio equals 0.90 to 0.99.

6. The display apparatus of claim 5, wherein each prism has two inclined surfaces, and each inclined surface has a width equal to the first distance.

7. The display apparatus of claim 6, wherein the first pixel aperture ratio equals 0.92, and the modulation value is less than 0.008 and greater than 0.000001.

8. The display apparatus of claim 7, wherein the pixel area has a width of about 90 μm, the light transmission area has a width of about 83.2 μm, and the first distance has a value of about 50 μm.

9. The display apparatus of claim 1, wherein the color filters comprise a red color filter, a blue color filter, and a green color filter.

10. The display apparatus of claim 9, wherein the green color filter is arranged in the first pixel area.

11. The display apparatus of claim 10, wherein a pixel area in which the red color filter is arranged has a pixel aperture ratio less than the first pixel aperture ratio.

12. The display apparatus of claim 10, wherein a pixel area in which the blue color filter is arranged has a pixel aperture ratio less than the first pixel aperture ratio.

13. The display apparatus of claim 10, wherein a pixel area in which the red color filter is arranged has a pixel aperture ratio equal to that of a pixel area in which the blue color filter is arranged.

14. The display apparatus of claim 10, where black matrix arranged in the light blocking area of the first pixel area is narrower than black matrix arranged in a light blocking area of a pixel area in which the red color filter is arranged or black matrix arranged in a light blocking area of a pixel area in which the blue color filter is arranged.

15. The display apparatus of claim 1, wherein each pixel area has the first pixel aperture ratio.

16. A display apparatus, comprising:
a light source unit to generate light;
a display panel comprising a base substrate including a plurality of pixel areas, each pixel area including a light transmission area and a light blocking area surrounding the light transmission area, color filters arranged in the pixel areas, and a black matrix arranged in the light blocking area; and
an optical member interposed between the light source unit and the display panel to collect light from the light source unit and to provide the display panel with the collected light,
wherein a pixel aperture ratio is a ratio of the light transmission area to a corresponding pixel area, and at least one pixel area has a pixel aperture ratio of 0.90 to 0.99 and a modulation value less than 0.01, and
wherein the modulation value equals a difference between maximum luminance and minimum luminance of the display panel in a gray scale higher than highlights divided by a sum of the maximum luminance and the minimum luminance.

17. The display apparatus of claim 16 wherein the optical member comprises a plurality of prisms, the prisms having triangular cross-sections, being arranged adjacent to each other, and having peaks spaced apart from each other at a first distance, and
wherein the modulation value is influenced by a ratio of a width of the pixel area to the first distance and the pixel aperture ratio.

18. The display apparatus of claim 17, where the first distance is equal to a width of each prism edge.
